(19) United States
(12) Patent Application Publication
(10) Pub. No.: US 2008/0061195 A1
(43) Pub. Date: Mar. 13, 2008

(54) Universal pole caddy

(76) Inventor: Jeffrey D. Carnevali, Seattle, WA (US)

Correspondence Address: CHARLES J RUPNICK, PO BOX 46752, SEATTLE, WA, 98146, US

(21) Appl. No.: 11/519,459

(22) Filed: Sep. 11, 2006

(51) Int. Cl. F16M 11/00; F16M 13/00

(52) U.S. Cl. 248/125.8

(57) ABSTRACT

A novel detachable pole caddy that is universally positionable by operating in a spherical coordinate system, and method for positionally adjusting the detachable pole caddy within the spherical coordinate frame. According to one aspect of the invention the novel detachable pole caddy is provided by two releasably interlockable rotationally and spherically rotatable ball-and-socket components that are formed between a substantially rigid spacing component and two part-spherical couplers. A pole clamp mechanism is coupled to one of the two part-spherical couplers, and a caddy is coupled to a different one of the two part-spherical couplers.

This application is related to co-pending patent applications Ser. No. ______ “Sheet Music Stand” (Attorney Docket No. NPI-060) and Ser. No. ______ “Universal Detachable Presentation Bracket” (Attorney Docket No. NPI-062) both filed in the name of the same inventor on the same day herewith, which are both incorporated herein by reference.

### FIELD OF THE INVENTION

The present invention relates generally to a bracket for holding a caddy to a pole, and more particularly, to a detachable bracket having a one or more ball-and-socket joints for spherically and rotationally positioning the caddy relative to the pole.

### BACKGROUND OF THE INVENTION

Detachable brackets for holding caddies are generally well-known and have an advantage in being conveniently carried on the body of an instrument while the instrument is played.

However, detachable caddies to date have been limited to use with a specific species of gear, such as cigarette packages and related smoking paraphernalia, irons, blueprints, weapons, cleaning supplies, etc. Known detachable caddies have also been limited in their ability to position the gear for the user's convenience. Known detachable caddies have been limited to single fixed positions relative to the stand or other object to which they are attached. Accordingly, known detachable caddies are very limited in their operation and positioning.

### SUMMARY OF THE INVENTION

The present invention is a novel universal detachable pole bracket that provides positional adjustments of a caddy within a spherical coordinate frame. According to one aspect of the invention, the novel bracket includes two releasably interlockable rotationally and spherically rotatable ball-and-socket components formed between a substantially rigid spacing component and two part-spherical couplers. A pole clamp mechanism is coupled to one of the two part-spherical couplers, the pole clamp mechanism being structured for attachment to a pole. A caddy is coupled to a different one of the two part-spherical couplers.

According to another aspect of the invention, the caddy is configured as an accessory support bracket that is coupled to the part-spherical coupler, the accessory support bracket has a drink container holder and is structured to support the drink container holder in a substantially upright orientation.

According to another aspect of the invention, the bracket further includes a coupler bracket intervening between the caddy and the part-spherical coupler, the intervening coupler bracket being configured as a flange having the part-spherical coupler presented on a substantially rigid stem projected from one side thereof and having with a mounting platform on a different side thereof from the stem.

According to another aspect of the invention, the caddy is configured as a conventional drink container holder coupled to the part-spherical coupler.

According to another aspect of the invention, at least a first one of the two part-spherical couplers is formed of a resiliently deformable material and has a substantially smooth part spherical outer surface. Additionally, the spacing component further includes two substantially rigid arm sections forming two pairs of sockets therebetween, and at least a first pair of the two pairs of sockets is configured with substantially smooth and rigid concave interior surfaces that are shaped to substantially conform to the part spherical outer surface portion of the first resiliently deformable part-spherical coupler.

According to another aspect of the invention, the bracket further includes an adjustable clamping mechanism that is operable between the two substantially rigid arm sections for urging the substantially smooth and rigid concave interior surfaces of the first pair of sockets to form a first one of the rotationally and spherically rotatable ball-and-socket components with the first resiliently deformable part-spherical coupler. The adjustable clamping mechanism is further configured to be operable incrementally between the two substantially rigid arm sections for urging the substantially smooth and rigid concave interior surfaces of the first pair of sockets to releasably interlock with the outer surface of the first resiliently deformable part-spherical coupler.

According to another aspect of the invention, a second one of the two part-spherical couplers is also formed of a resiliently deformable material and has a substantially smooth part spherical outer surface. Also, a second pair of the two pairs of sockets formed between substantially rigid arm sections is configured with substantially smooth and rigid concave interior surfaces that are shaped to substantially conform to the part spherical outer surface portion of the second resiliently deformable part-spherical coupler. Additionally, the adjustable clamping mechanism is further configured to be operable incrementally between the two substantially rigid arm sections for urging the substantially smooth and rigid concave interior surfaces of the second pair of sockets to form a second one of the rotationally and spherically rotatable ball-and-socket components with the second resiliently deformable part-spherical coupler, and is configured to be further operable between the two substantially rigid arm sections for urging the substantially smooth and rigid concave interior surfaces of the second pair of sockets to releasably interlock with the outer surface of the second resiliently deformable part-spherical coupler.

According to another aspect of the invention, the bracket also includes a differential biasing mechanism coupled between the arm sections of the spacing component for differentially urging apart one of the first and second pairs of sockets, and is further coupled for urging together a different one of the first and second pairs of sockets.

According to another aspect of the invention, a method is provided for positionally adjusting a detachable caddy within a spherical coordinate frame. According to one aspect of the method of the invention, the method includes providing two releasably interlockable rotationally and spherically rotatable ball-and-socket components between a substantially rigid spacing component and two part-spherical couplers. The method of the invention also includes coupling a pole clamp mechanism to one of the two part-spherical couplers; coupling a caddy to a different one of the two part-spherical couplers; spherically rotating one or both of the two part-spherical couplers relative to the substantially rigid spacing component for spherically and rotationally adjusting a position and orientation of one of the caddy relative to the pole clamp mechanism, and subsequently releasably interlocking both of the two ball-and-socket components.

According to another aspect of the invention, the method further includes forming at least a first one of the two part-spherical couplers of a resiliently deformable material having a substantially smooth part spherical outer surface.

According to another aspect of the method of the invention, the step of providing two releasably interlockable rotationally and spherically rotatable ball-and-socket components between a substantially rigid spacing component and two part-spherical couplers further includes forming two pairs of sockets between two substantially rigid arm sections, including forming at least a first pair of the two pairs of sockets with substantially smooth and rigid concave interior surfaces shaped to substantially conform to the part spherical outer surface portion of the first resiliently deformable part-spherical coupler.

According to another aspect of the invention, the method further includes operating an adjustable clamping mechanism between the two substantially rigid arm sections for initially urging the substantially smooth and rigid concave interior surfaces of the first pair of sockets to form a first one of the rotationally and spherically rotatable ball-and-socket components with the first resiliently deformable part-spherical coupler, and further operating the adjustable clamping mechanism between the two substantially rigid arm sections for subsequently urging the substantially smooth and rigid concave interior surfaces of the first pair of sockets to releasably interlock with the outer surface of the first resiliently deformable part-spherical coupler.

According to another aspect of the invention, the method further includes forming a second one of the two part-spherical couplers of a resiliently deformable material having a substantially smooth part spherical outer surface. Also, the step of forming two pairs of sockets between two substantially rigid arm sections further includes forming a second pair of the two pairs of sockets with substantially smooth and rigid concave interior surfaces shaped to substantially conform to the part spherical outer surface portion of the second resiliently deformable part-spherical coupler. The step of operating an adjustable clamping mechanism between the two substantially rigid arm sections further includes operating the adjustable clamping mechanism for urging the substantially smooth and rigid concave interior surfaces of the second pair of sockets to form a second one of the rotationally and spherically rotatable ball-and-socket components with the second resiliently deformable part-spherical coupler, and further operating the adjustable clamping mechanism between the two substantially rigid arm sections for urging the substantially smooth and rigid concave interior surfaces of the second pair of sockets to releasably interlock with the outer surface of the second resiliently deformable part-spherical coupler.

According to another aspect of the invention, the method further includes urging apart one of the first and second pairs of sockets, and substantially simultaneously urging together a different one of the first and second pairs of sockets.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of the pole caddy of the invention attached to a conventional pole-type device stand;

FIG. 2 is another perspective view showing an example of the pole caddy of the invention;

FIG. 3 illustrates one optional pole clamp mechanism usable with the pole caddy of the invention;

FIG. 4 illustrates another optional pole clamp mechanism usable with the pole caddy of the invention;

FIG. 5 is an assembly view that illustrates the different components of the pole caddy of the invention; and

FIG. 6 is another assembly view that illustrates the different components of the pole caddy of the invention;

FIG. 7 illustrates an example of a different pole caddy of the invention;

FIG. 8 is another view of the different pole caddy of the invention illustrated in FIG. 7; and

FIG. 9 is another view of the different pole caddy of the invention illustrated in FIG. 7 having a different caddy and pole clamp mechanism.

### DETAILED DESCRIPTION OF PREFERRED EMBODIMENT

In the Figures, like numerals indicate like elements.

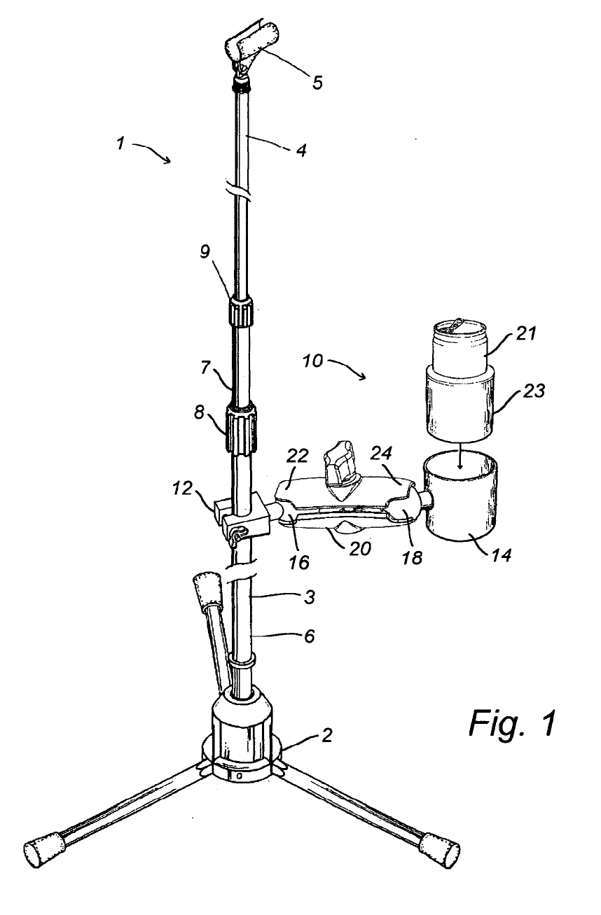

FIG. 1 is a perspective view that illustrates the universal detachable pole bracket 10 of the invention is operable with a conventional pole-type device stand 1. By example and without limitation, the conventional pole-type device stand 1 is embodied as a conventional microphone stand assembly, which generally includes a leg base 2, a post 3, a holder rod 4, and a microphone holder 5. The post 3 includes, for example, a lower tube 6 and an upper tube 7 slidably received in the lower tube 6. A clamping sleeve 8 is provided to hold the upper tube 7 in place relative to the lower tube 6. The upper tube 7 slidably receives a lower end of the holder rod 4. The holder rod 4 is secured to the upper tube 7 by a clamping sleeve 9 to determine the height position of the holder rod 4 with the microphone holder 5 joined to the upper end. In addition, the angular position of the microphone holder 5 can be adjusted relative to the holder rod 4. See, e.g., U.S. Pat. No. 6,007,032, “Foldable Stand Assembly For Microphones” issued Dec. 28, 1999, which is incorporated herein by reference. See, also, U.S. Pat. No. 6,774,293 “Quick-Release Device For A Music Support Stand” issued Aug. 10, 2004, which is incorporated herein by reference. Also, see, US Design Patent 286,478 “Combined Music and Microphone Support Stand” issued Nov. 4, 1986, which is also incorporated herein by reference.

The conventional pole-type device stand 1 is alternatively embodied as another conventional pole-type device stand. For example, the pole-type device stand 1 is embodied as a conventional pole-type music stand of the type disclosed in one of U.S. Pat. No. 3,637,172 “Music Stand” issued Jan. 25, 1972; U.S. Pat. No. 4,372,518 “Music Stand Extender” issued Feb. 8, 1983; U.S. Pat. No. 4,471,933 “Music Stand” issued Sep. 18, 1984; U.S. Pat. No. 4,561,339 “Music Stand for Guitar Player” issued Dec. 31, 1985; U.S. Pat. No. 4,605,193 “Foldable Music Stand” issued Aug. 12, 1986; U.S. Pat. No. 4,606,525 “Height Adjustment of Music Stand” issued Aug. 19, 1986; U.S. Pat. No. 4,813,644 “Telescoping Music Stand” issued Mar. 21, 1989; U.S. Pat. No. 4,819,902 “Collapsible Music Stand” issued Apr. 11, 1989; U.S. Pat. No. 5,037,057 “Collapsible Music Stand” issued Aug. 6, 1991; U.S. Pat. No. 5,114,511 “Music Stand” issued May 19, 1992; U.S. Pat. No. 5,636,824 “Music Stand” issued Jun. 10, 1997; U.S. Pat. No. 5,692,719 “Sheet Music Stand” issued Dec. 2, 1997; U.S. Pat. No. 5,833,199 “Music Stand” issued Nov. 10, 1998; U.S. Pat. No. 5,918,997 “Sleeve for a Music Stand” issued Jul. 6, 1999; U.S. Pat. No. 5,979,856 “Music Stand” issued Nov. 9, 1999; U.S. Pat. No. 6,017,011 “Collapsible Music Stand with Optional Multiple Desks Having Dual-Angular and Vertical Adjustability” issued Jan. 25, 2000; U.S. Pat. No. 6,145,639 “Guitar Stand Music Bag” issued Nov. 14, 2000; U.S. Pat. No. 6,193,204 “Music Stand” issued Feb. 27, 2001; U.S. Pat. No. 6,260,812 “Arrangement in a Stand, Especially a Music Stand” issued Jul. 17, 2001; U.S. Pat. No. 6,264,161 “Portable Music Stand” issued Jul. 24, 2001; U.S. Pat. No. 6,293,511 “Sheet Music Stand” issued Sep. 25, 2001; U.S. Pat. No. 6,450,462 “Retaining Device for a Telescoping Music Stand” issued Sep. 17, 2002; U.S. Pat. No. 6,536,720 “Music Stand” issued Mar. 25, 2003; U.S. Pat. No. 6,682,042 “Collapsible Music Stand” issued Jan. 27, 2004; U.S. Pat. No. 6,774,293 “Quick Release Device for a Music Support Stand” issued Aug. 10, 2004; and U.S. Pat. No. 6,808,153 “Collapsible Music Stand With Light” issued Oct. 26, 2004, the complete disclosures of which are incorporated herein by reference. Also see, US Design Patents 276,779; 314,873; 343,517; 367,971; 388, 262; 408,650 and 433,581, which are all incorporated herein by reference.

By example and without limitation, the pole-type device stand 1 is alternatively embodied as a conventional pole-type stand for use by a surveyor, the pole-type stand being of the type disclosed in U.S. Pat. No. 3,239,176 “Surveyor's Level Rod and Range Pole Holder” issued Sep. 2, 1964, which is incorporated herein by reference. The pole-type device stand 1 is alternatively the type disclosed in either of U.S. Pat. No. 4,339,880 “Device For Holding Surveyor's Instrument” issued Jul. 20, 1982, or U.S. Pat. No. 4,926,561 “Tripod Stand For A Surveyor's Rod” issued May 22, 1990, which are both incorporated herein by reference.

By example and without limitation, the pole-type device stand 1 is alternatively embodied as a conventional pole-type accessory tray device of the type disclosed by example and without limitation in U.S. Pat. No. 5,114,676 “Accessory Tray for Use in Surgery” issued Apr. 30, 1996, which is incorporated herein by reference.

Alternatively, other conventional pole-type device stands are also contemplated and may be substituted without departing from the spirit and scope of the invention. For example, the pole-type device stand 1 is alternatively embodied as a collapsible stand for an upright vertical support of the type disclosed by example and without limitation in U.S. Pat. No. 4,492,354 “Collapsible Stand For Roller Support” issued Jan. 8, 1985, which is incorporated herein by reference, or more generally by U.S. Pat. No. 5,320,316 “Portable Stands Or Supports” issued Jun. 14, 1994, and U.S. Pat. No. 7,048,241 “Geomatic Support Having Hinged Legs With Hinge Lock” issued May 23, 2006, which are incorporated herein by reference.

The universal detachable pole bracket 10 of the present invention is thus believed to be structured for attachment to substantially any pole-type device stand 1.

Here, the universal detachable pole bracket 10 of the invention is useful for supporting a caddy 14 on the pole-type device stand 1. Here, the caddy 14 is defined according to Webster's Collegiate Dictionary, Tenth Edition, as a device for storing or holding objects when they are not in use. By example and without limitation, the caddy 14 is illustrated here a conventional ring-type or cup-type holder for holding an individual serving can or bottle drink container, for example as described in U.S. Pat. No. 4,596,370 “Container Holder” issued to George H. Adkins on Jun. 24, 1986, which is incorporated herein by reference. See, also, U.S. patent application Ser. No. 10/352,330, Publication No. 2004/0144904 “Universally Positionable Platform For Beverage Holder” by the inventor of the instant application filed on Jan. 27, 2003, which is incorporated herein by reference. The universal detachable pole bracket 10 of the invention provides positional adjustments of the caddy 14 within a spherical coordinate frame by means of two rotationally and spherically adjustable ball-and-socket components that are spaced apart on a single spacing component.

Accordingly, the universal detachable pole bracket 10 of the invention includes the caddy 14 and a pole-type clamp 12 each having a respective attached part-spherical coupler 16, 18. A double-socket spacing mechanism 20 extends between and joins the two part-spherical couplers 16, 18 in a pair of spaced-apart ball-and-socket joints 22, 24, respectively. Both of the ball-and-socket joints 22, 24 are adjustable both rotationally and spherically relative to the intervening spacing mechanism 20. Accordingly, the universal detachable pole bracket 10 of the invention provides positional adjustments of the caddy 14 relative to the pole clamp 12 within a spherical coordinate frame, whereby a beverage container 21 can be received in a position desired by the user. Optionally, the caddy 14 is adapted to receive an insulation sleeve 23 partially encasing the beverage container 21.

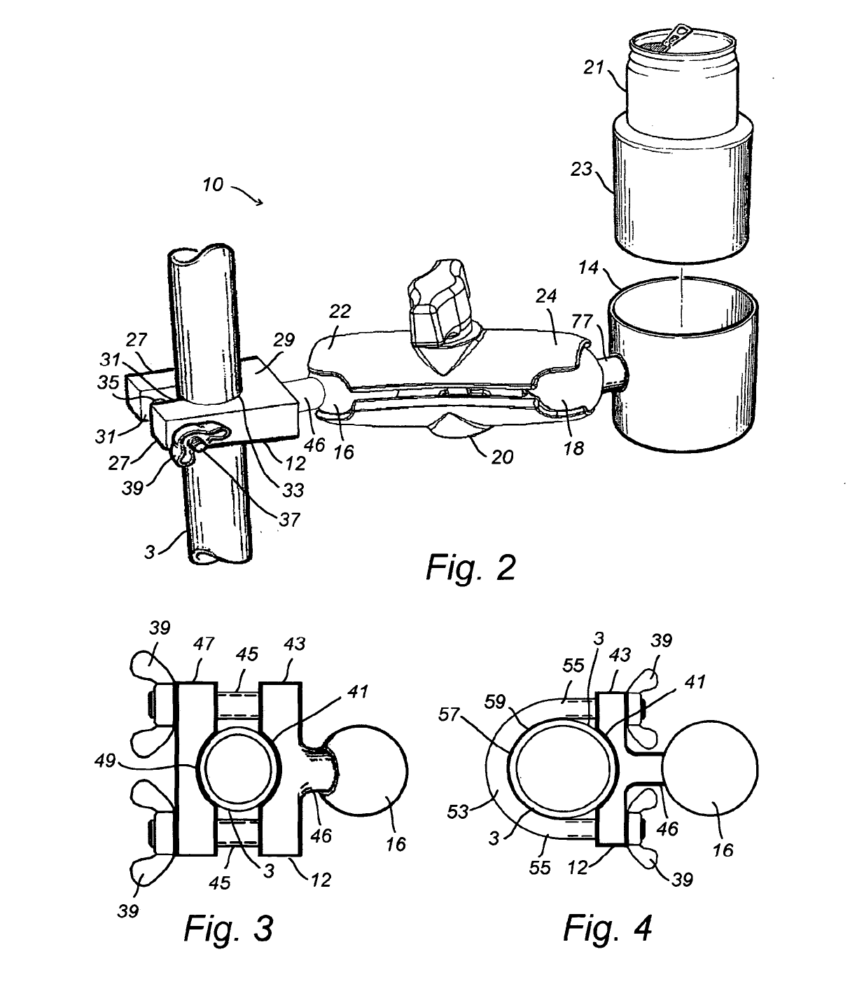

FIG. 2 is a close up view of the universal detachable pole bracket 10 of the invention. As illustrated here by example and without limitation, the double-socket spacing mechanism 20 is operable in a first loosely clamped state for forming first and second spaced-apart and relatively rotatable ball-and-socket joints 22, 24 with the two part-spherical couplers 16, 18. The double-socket spacing mechanism 20 is also operable in a second partially clamped state for securely interlocking with the spacing mechanism 20 with an outer surface of the first part-spherical coupler 16, while retaining the second relatively rotatable ball-and-socket joint 24 with the second part-spherical coupler 18. The double-socket spacing mechanism 20 is further operable in a third fully clamped state for securely interlocking the spacing mechanism 20 with both of the two part-spherical couplers 16, 18. Therefore, with the pole clamp 12 securely attached to the post 3 portion of the pole-type device stand 1, the double-socket spacing mechanism 20 is operated in the first loosely clamped state for forming the two relatively rotatable ball-and-socket joints 22, 24 with the two part-spherical couplers 16, 18 so that the double-socket spacing mechanism 20 can be rotated about each of the two part-spherical couplers 16, 18 in any orientation within range of the device. Next, with the pole clamp 12 still securely attached to the post 3 portion of the pole-type device stand 1, the double-socket spacing mechanism 20 is operated in the second partially clamped together state for securely interlocking with the spacing mechanism 20 with the first part-spherical coupler 16 on the securely attached pole clamp 12, while the second relatively rotatable ball-and-socket joint 24 is retained with the second part-spherical coupler 18. Thus, the spacing mechanism 20 is securely clamped in a selected orientation with the pole clamp 12 and the post 3 portion of the pole-type device stand 1, while the caddy 14 is still rotatable about the second relatively rotatable ball-and-socket joint 24 formed between the spacing mechanism 20 and the second part-spherical coupler 18. When the caddy 14 is rotated into the selected spherical position and orientation relative to the pole clamp 12 and the post 3 portion of the pole-type device stand 1, the double-socket spacing mechanism 20 is operated in the third fully clamped state for securely interlocking the spacing mechanism 20 with both of the two part-spherical couplers 16, 18. Thereafter, the spacing mechanism 20 is securely interlocked with the two part-spherical couplers 16, 18, and through them interlocks the caddy 14 with the pole clamp 12 and the post 3 portion of the pole-type device stand 1, whereby the caddy 14 is immovably secured in the selected spherical position and orientation. The drink container 21 can be fitted into the caddy 14 in a substantially upright orientation in a position that is convenient to the person using the pole-type device stand 11.

Partial loosening causes the spacing mechanism 20 to retreat from the third clamped fully clamped state to the second partially clamped state, wherein the spacing mechanism 20 reforms the second relatively rotatable ball-and-socket joint 24 with the second part-spherical coupler 18, but remains securely interlocked to the first part-spherical coupler 16 on the pole clamp 12. Thus, the caddy 14 is easily reoriented and repositioned spherically relative to the securely interlocked spacing mechanism 20, the pole clamp 12 and the post 3 portion of the pole-type device stand 1, without changing either the rotational or the spherical orientation of the spacing mechanism 20 relative to the pole clamp 12.

Additional loosening causes the spacing mechanism 20 to retreat from the second partially clamped state to the first loosely clamped state, wherein the spacing mechanism 20 continues to form the second relatively rotatable ball-and-socket joint 24 with the second part-spherical coupler 18, and additionally reforms the first relatively rotatable ball-and-socket joint 22 with the first part-spherical coupler 16. Thus, the caddy 14 remains easily spherically reorientable and repositionable relative to the spacing mechanism 20, and the spacing mechanism 20 is easily spherically reoriented and repositioned relative to the pole clamp 12 which is still securely attached to the post 3 portion of the pole-type device stand 1.

Here, the pole-type clamp 12 is illustrated by example and without limitation as the type described in U.S. Pat. No. 4,596,370, which is incorporated herein by reference. By example and without limitation, the pole clamp 12 is formed with two spaced apart downward extending arms 27 fixedly attached to a yoke 29 with the first part-spherical coupler 16 extended therefrom on a rigid stem 46 necked-down to be smaller than the part-spherical coupler 16. Inward directed surfaces 31 are concave for forming a generally round aperture 33. Aligned apertures 35 (one shown) at outer or distal ends of extending arms 27 receive a bolt 37 therethrough. One end of the bolt 37 is threaded to receive a wing nut 39. Obviously, the tightening of the nut 39 on the bolt 37 moves the outer or distal ends of the extending arms 27, thereby reducing the size of the aperture 33 formed by the opposing concave surfaces 31. In this manner, the clamp 12 can be adjusted to grip various different sizes of the pole-type device stand 1.

FIG. 3 illustrates by example and without limitation an alternative of the pole clamp 12 having a concave surface 41 formed on one side of a yoke 43 with the first part-spherical coupler 16 extended from the opposite side on the necked-down rigid stem 46. Two bolts 45 extend from the yoke 43 on opposite sides of the concave surface 41 and pass through a backing plate 47 having a matching concave surface 49. A pair of the wing nuts 39 secure the backing plate 47 to the yoke 43. Tightening of the nuts 39 on the bolts 45 moves the backing plate 47, thereby reducing the size of an aperture 51 formed by the opposing concave surfaces 41 and 49. In this manner, the clamp 12 can be adjusted to grip various different sizes of the pole 3 of the pole-type device stand 1.

FIG. 4 illustrates by example and without limitation another alternative of the pole clamp 12 having the yoke 43 with the concave surface 41 formed on one side and the first part-spherical coupler 16 extended from the opposite side on the necked-down rigid stem 46. A single U-bolt 53 extends two threaded arms 55 around the pole 3 of the pole-type device stand 1 and pass through the yoke 43 on opposite sides of the concave surface 41. A pair of the wing nuts 39 secure the U-bolt 53 to the yoke 43. Tightening of the nuts 39 on the U-bolt 53 moves a concave surface 57 thereof toward the opposing concave surface 41 of the yoke 43, thereby reducing the size of an aperture 59 formed by therebetween. In this manner, the clamp 12 can be adjusted to grip various different sizes of the pole 3 of the pole-type device stand 1.

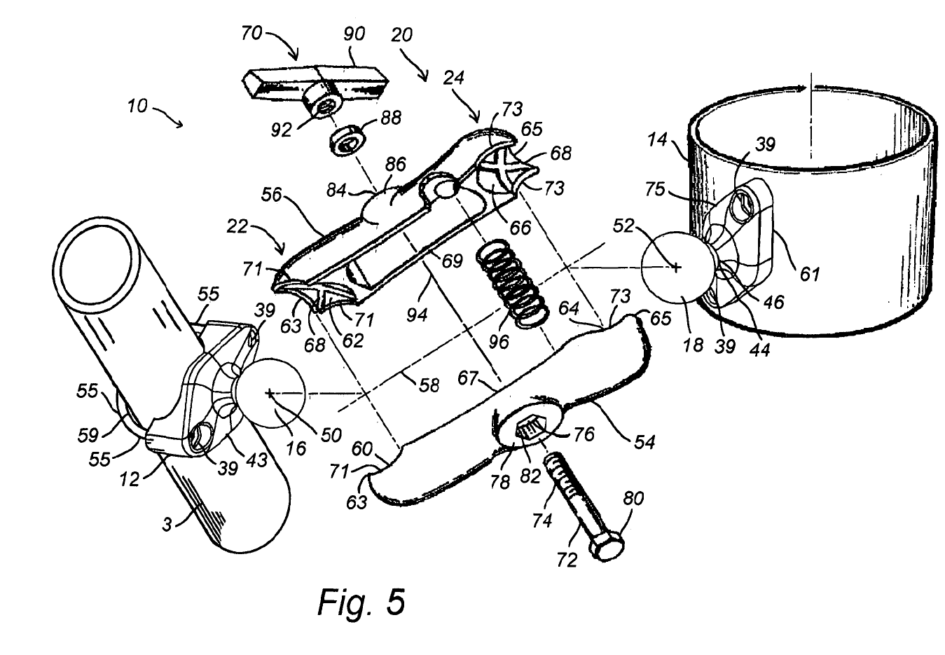

FIG. 5 is an assembly view of the universal detachable pole bracket 10 of the invention. Here, the pole clamp 12 is embodied by example and without limitation as illustrated in FIG. 4 having the U-bolt 53 wherein tightening of nuts 39 against the yoke 43 securely attach the first part-spherical coupler 16 to the post 3 portion of the pole-type device stand 1.

Alternatively, other conventional pole clamp devices are also contemplated and may be substituted therefor without departing from the spirit and scope of the invention. For example, one of the other pole clamps 12 illustrated herein may be substituted for the illustrated pole clamp 12 without departing from the spirit and scope of the invention.

The two part-spherical couplers 16 and 18 are formed of a resiliently deformable material having a substantially smooth part spherical outer surface, as disclosed by U.S. Pat. No. 5,885,845 for “Universally Positionable Mounting Device,” issued to the inventor of the present invention on Dec. 8, 1998, which is incorporated herein by reference.

The first part-spherical coupler 16 is securely coupled to the pole clamp 12. For example, the first part-spherical coupler 16 is projected above the yoke 43 on the rigid stem 46 which is necked-down to be smaller than the part-spherical coupler 16. The yoke 43 is securely fastened to the post 3 by the U-bolt 53. Alternatively, other pole clamp devices may be substituted without departing from the spirit and scope of the invention.

The caddy 14 may be provided as illustrated in previous Figures having the second part-spherical coupler 18 projected therefrom on another stem 77 that is necked-down to be smaller than the part-spherical coupler 18 and to pass between the indentations 73 in the respective peripheral rims 65 of the sockets 64, 66. Alternatively, the caddy 14 is shown here being mounted on an intervening coupler bracket 75. The intervening coupler bracket 75 is illustrated here by example and without limitation as a diamond-shaped flange 44 having the second part-spherical coupler 18 projected from one surface on the necked-down stem 77. A mounting platform 61 is provided opposite from the necked-down stem 77 and coupler 18. The mounting platform 61 of the diamond-shaped flange 44 is securely attached to an exterior surface 48 of the caddy 14 with the second part-spherical coupler 18 is projected above the flange 44 on the rigid stem 77. Alternatively, other conventional flange devices are also contemplated and may be substituted for the diamond-shaped flange 44 without departing from the spirit and scope of the invention. For example, a round flange device may be substituted for the diamond-shaped flange 44 without departing from the spirit and scope of the invention. Alternatively, the flange 44 may be integrally formed with the caddy 14 and its exterior surface 48.

The double-socket spacing mechanism 20 operates in conjunction with the first and second part-spherical couplers 16 and 18 to compose the mounting device for alternately providing relative motion and fixed positions between two relatively movable objects at selected angular orientations, as disclosed in U.S. Pat. No. 5,885,845, which is incorporated herein by reference. By example and without limitation, the first and second part-spherical couplers 16 and 18 are provided on the pole clamp 12 and caddy 14, respectively. The geometric centers of the first and second part-spherical couplers 16 and 18 define spaced first and second loci 50 and 52, respectively.

The double-socket spacing mechanism 20 is a split arm assembly having a pair of substantially identical relatively rigid arm sections 54 and 56 that are operatively juxtaposed to one another along a line of juncture 58 between the spaced loci 50, 52. Pairs of sockets 60, 62 and 64, 66 are formed in opposite ends of the rigid arm section 54, 56, respectively. The sockets 60, 62 and 64, 66 each have respective interior surfaces shaped to substantially conform to the part-spherical outer surface portion of the first and second part-spherical couplers 16 and 18. The interior surfaces of the sockets 60, 62 and 64, 66 are substantially smooth and rigid concave surfaces, wherein one or more of the smooth concave surfaces optionally includes one or more indentations 68 formed therein, e.g., crossed as shown.

The arm sections 54, 56 of the double-socket spacing mechanism 20 are clamped together relatively crosswise the line of juncture 58 in a plurality of clamped together positions, whereby the first and second pairs of sockets 60, 62 and 64, 66 are repositioned relative to the respective part-spherical couplers 16, 18 for sequentially forming each of the first loosely clamped state, the second partially clamped state, and the third fully clamped state. In the first loosely clamped state of the double-socket spacing mechanism 20 the first pair of sockets 60, 62 is joined with the outer surface of the first part-spherical coupler 16 to form the first relatively rotatable ball-and-socket joint 22 having a first sphere of revolution with a center at the center 50 of the first part-spherical coupler 16; and the second pair of sockets 64, 66 is loosely joined with the outer surface of the second part-spherical coupler 18 to form the second relatively rotatable ball-and-socket joint 24 having a first sphere of revolution with a center at the center 52 of the second part-spherical coupler 18. Thus, in the first loosely clamped state of the double-socket spacing mechanism 20 the arm sections 54, 56 are freely movable relative to both the pole clamp 12 and the caddy 14. Accordingly, within the range of the device the caddy 14 can be easily moved to any position and any orientation relative to the pole clamp 12 and the post 3 of the pole-type device stand 1 to which it is securely attached.

In the second partially clamped state of the double-socket spacing mechanism 20 the first pair of sockets 60, 62 is securely interlocked with the outer surface of the first part-spherical coupler 16, while the second pair of sockets 64, 66 remains loosely joined with the outer surface of the second part-spherical coupler 18 to form the second relatively rotatable ball-and-socket joint 24 having a first sphere of revolution with a center at the center 52 of the second part-spherical coupler 18. Thus, in the second partially clamped state of the double-socket spacing mechanism 20 the arm sections 54, 56 are securely fixed in both position and orientation relative to the pole clamp 12. However, the caddy 14 remains freely movable relative to the arm sections 54, 56. Accordingly, within the range of the device the caddy 14 can be easily moved to any position and any spherical orientation relative to the arm sections 54, 56, the pole clamp 12 and the post 3 of the pole-type device stand 1.

In the third fully clamped state of the double-socket spacing mechanism 20 the first pair of sockets 60, 62 remain securely interlocked with the outer surface of the first part-spherical coupler 16, while the second pair of sockets 64, 66 is securely interlocked with the outer surface of the second part-spherical coupler 18. Thus, in the third fully clamped state of the double-socket spacing mechanism 20 the arm sections 54, 56 are securely fixed and substantially immovable in both position and orientation relative to arm sections 54, 56, the pole clamp 12 and the post 3 of the pole-type device stand 1.

The double-socket spacing mechanism 20 includes an adjustable clamping mechanism 70 for clamping the arm section 54, 56 and causing the opposing concave socket surfaces of the sockets 60, 62 and 64, 66 to assume different adjustment relationships to the respective first and second part-spherical couplers 16, 18 that apply differential clamping forces between the interior concave surfaces of the respective pairs of sockets 60, 62 and 64, 66. Accordingly, the clamping mechanism 70 is sequentially adjustable for clamping the arm section 54, 56 to different degrees for causing the double-socket spacing mechanism 20 to initially assume the first loosely clamped state for forming first and second relatively rotatable ball-and-socket joints 22, 24 with the two part-spherical couplers 16, 18; and for subsequently assuming each of the second partially clamped state for securely interlocking the spacing mechanism 20 with an outer surface of the first part-spherical coupler 16, while retaining the second relatively rotatable ball-and-socket joint 24 with the second part-spherical coupler 18; and the third fully clamped state for securely interlocking the spacing mechanism 20 with both of the two part-spherical couplers 16, 18.

By example and without limitation, the adjustable clamping mechanism 70 is formed by a threaded bolt 72 having a threaded shaft 74 sized to pass through an aperture 76 formed through a boss 78 formed adjacent to a central portion the body of one arm section 54 (or 56). A head 80 of the bolt 72 nests in a socket 82 formed in the boss 78. The bolt's shaft 74 subsequently passes through a bore 84 through another boss 86 formed in a central portion the body of the other arm section 56 (or 54). A washer 88 is fitted over the bolt's shaft 74 adjacent to the boss 86. A handle or knob 90 with a threaded bore 92 is threadedly coupled to the bolt's shaft 74. Thereafter, tightening of the adjustable clamping mechanism 70 by turning the knob 90 along a drive axis 94 of the adjustable clamping mechanism 70 in a first direction onto the bolt's shaft 74 against the boss 86 adjusts first and second relatively spherically rotatable ball-and-socket joints 22, 24 relative to the two part-spherical couplers 16, 18 for sequentially forming each of the first loosely clamped state, the second partially clamped state, and the third fully clamped state wherein the spacing mechanism 20 is securely interlocked with both of the two part-spherical couplers 16, 18. Subsequent loosening of the adjustable clamping mechanism 70 by turning the knob 90 in reverse direction off of the bolt's shaft 74 and away from the boss 86 adjusts first and second relatively rotatable ball-and-socket joints 22, 24 relative to the two part-spherical couplers 16, 18 for retreating from the third fully clamped state for forming the second partially clamped state wherein the spacing mechanism 20 is securely interlocked with the outer surface of the first part-spherical coupler 16, while permitting the spacing mechanism 20 to form the second relatively rotatable ball-and-socket joint 24 with the second part-spherical coupler 18. Continued turning of the knob 90 in the reverse direction off of the bolt's shaft 74 and away from the boss 86 eventually adjusts the double-socket spacing mechanism 20 to achieve the first loosely clamped state for forming the first and second relatively rotatable ball-and-socket joints 22, 24 with each of the two part-spherical couplers 16, 18.

Alternatively, other conventional adjustable clamping mechanisms are also contemplated and may be substituted for the adjustable clamping mechanism 70 without departing from the spirit and scope of the invention. For example, an over-center cam-type clamp mechanism may be substituted for the threadedly adjustable clamping mechanism 70 without departing from the spirit and scope of the invention.

Optionally, the double-socket spacing mechanism 20 may include a resilient differential biasing mechanism 96 positioned for differentially urging the two arm section 54, 56 apart from one another. The resilient differential biasing mechanism 96, for example, a conventional compression spring, is positioned between the two arm section 54, 56 at a location between the drive axis 94 of the adjustable clamping mechanism 70 and one of the ball-and-socket joints 22 or 24 (shown) adjacent to the end of the spacing mechanism 20. The differential biasing mechanism 96 operates to force the two arm section 54, 56 apart from one another at the nearer of the ball-and-socket joints 22 or 24 (shown), and simultaneously operates to force the two arm section 54, 56 toward one another at the farther of the ball-and-socket joints 24 or 22 (shown) by rotating or “rocking” the two arm section 54, 56 about the bolt 72 of the clamping mechanism 70 at the drive axis 94 thereof. Thus, the resilient biasing mechanism 96 generates a differential in the clamping forces between first and second pairs of sockets 60, 62 and 64, 66 vis-à-vis their respective part-spherical couplers 16 and 18. Accordingly, when the clamping mechanism 70 is partially engaged with the arm sections 54, 56 at the respective bosses 78, 86 thereof, the operation of the resilient biasing mechanism 96 causes the double-socket spacing mechanism 20 to enter the second partially clamped state by forcing together the arm section 54, 56 on the far side of the drive axis 94 for causing the first pair of sockets 60, 62 to engage and at least partially interlock with the outer surface of the first part-spherical coupler 16, while forcing apart the arm section 54, 56 on the near side of the drive axis 94 for the second pair of sockets 64, 66 to remain loosely joined with the outer surface of the second part-spherical coupler 18 to form the second relatively rotatable ball-and-socket joint 24.

Furthermore, the sockets 60, 62 and 64, 66 each have respective peripheral rims 63, 65 formed thereabout in the faces 67, 69 of the respective arm sections 54, 56 adjacent to their respective ends. The peripheral rims 63, 65 include one or more indentations 71, 73 in the outline of the respective sockets 60, 62 and 64, 66. The indentations 71, 73 are sized larger than the respective necks or stems 46 and 77 to pass there around. The indentations 71, 73 are formed as cooperating indentations positioned between the respective sockets 60, 62 and 64, 66 and are deep enough to permit the spacing mechanism 20 to be rotated about the center points or loci 50, 52 of the respective part-spherical couplers 16, 18 to angular orientations in which the line of juncture 58 can extend at right angles to the respective stems 46 and 77.

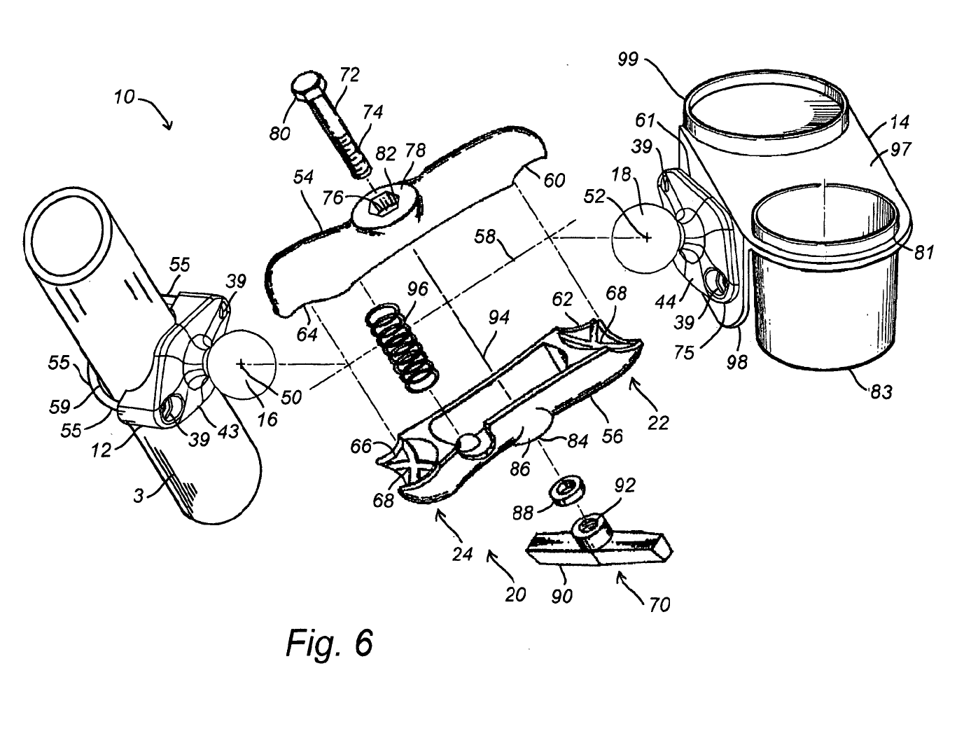

FIG. 6 is another assembly view of the universal detachable pole bracket 10 of the invention. Here, the pair of substantially identical relatively rigid arm sections 54 and 56 of the double-socket spacing mechanism 20 are inverted relative to the pole clamp 12 and caddy 14. The first pair of sockets 60, 62 is positioned to engage the second part-spherical coupler 18 and form the first relatively rotatable ball-and-socket joint 22 therewith. The second pair of sockets 64, 66 is positioned to engage the first part-spherical coupler 16 and form the second relatively rotatable ball-and-socket joint 24 therewith. Accordingly, operation of the adjustable clamping mechanism 70 on the arm section 54, 56 causes the opposing concave socket surfaces of the sockets 60, 62 and 64, 66 to instead assume the different adjustment relationships described herein with to the second and first part-spherical couplers 18 and 16, respectively.

Here, the caddy 14 is configured as a general accessory support bracket with the universal detachable pole bracket 10 of the invention presenting the caddy 14 in the vicinity of the pole-type device stand 1. By example and without limitation, the caddy 14 is an accessory support bracket formed of a substantially rigid metal, plastic or polycarbonate frame having a frame 97 with a mounting flange 98 adjacent to one edge. The second part-spherical coupler 18 is optionally projected directly from the mounting flange 98 on the necked-down stem 77. Alternatively, the second part-spherical coupler 18 is shown here as being presented on an intervening coupler bracket 75. Accordingly, the second part-spherical coupler 18 is projected from the coupler bracket's flange 44 on the stem 77, and the mounting flange 98 of the caddy 14 is securely attached to the mounting platform 61 of the flange 44.

The caddy's frame 97 is structured to operate as a drink container holder, for example, with a round aperture 81 sized to receive a conventional individual serving can or bottle drink container. Alternatively, as illustrated here by example and without limitation the caddy's frame 97 is equipped with a cup-type holder 83 structured for holding an individual serving can or bottle drink container, for example as described in U.S. Pat. No. 4,596,370, which is incorporated herein by reference, or in U.S. patent application Ser. No. 10/352,330, Publication No. 2004/0144904, which is incorporated herein by reference.

The caddy's frame 97 is optionally structured to include a small tray 99 of a type that is suitable for holding small amounts of different items, such as candies, nuts or other snacks that may be desirable to person using the pole-type device stand 1. Alternatively, the small tray 99 is configured as an ash tray for holding one or more cigarettes, cigars or a pipe, and the ashes generated thereby.

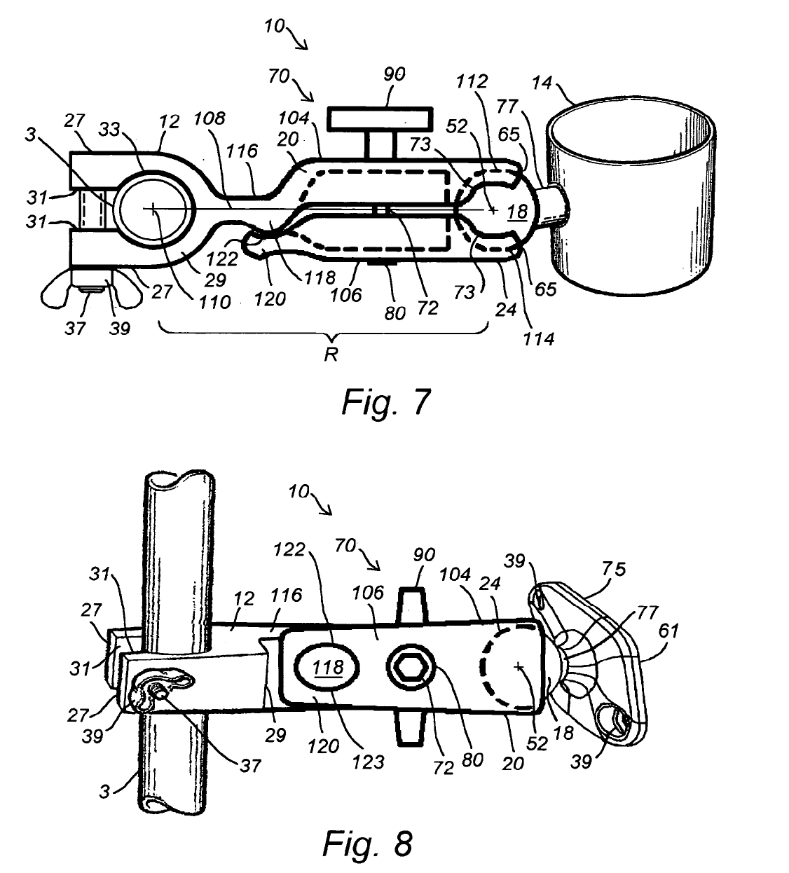

FIG. 7 illustrates universal detachable pole bracket 10 of the invention wherein the spacing mechanism 20 includes the pole clamp 12 in place of the first part-spherical coupler 16. Here, the spacing mechanism 20 is provided by a pair of dissimilar relatively rigid arm sections 104 and 106 that are substituted for the substantially identical arm sections 54 and 56. The cooperating arm sections 102 and 104 are operatively juxtaposed to one another along the a line of juncture 108 that coincides with the locus 52 of the second part-spherical coupler 18. By example and without limitation, the line of juncture 108 is shown here as intersecting a locus 110 of the post 3 of the pole-type device stand 1. A pair of sockets 112 and 114 are formed in distal ends of the respective rigid arm sections 104, 106. The sockets 112, 114 each have respective interior surfaces shaped to substantially conform to the part-spherical outer surface portion of the second part-spherical coupler 18. The interior surfaces of the sockets 112, 114 are substantially smooth and rigid concave surfaces that form the second relatively rotatable ball-and-socket joint 24 having the first sphere of revolution with its center at the center 52 of the second part-spherical coupler 18, as discussed herein above. The smooth concave interior surfaces of one or both of the sockets 112, 114 optionally includes one or more of the indentations 68 formed therein, e.g., crossed as illustrated in earlier Figures.

The first rigid arm section 104 includes the pole clamp 12 at an opposite end of a substantially rigid arm 116 distal from its socket 112 and the second ball-and-socket joint 24. The locus 52 of the second relatively rotatable ball-and-socket joint 24 is positioned at a radial distance R from the locus 110 of the post 3 along the line of juncture 108 that is determined by selection of the length of the extension arm 116. The pole clamp 12 is shown here as being generally configured as illustrated in FIG. 2. However, other conventional pole clamp devices are also contemplated and may be substituted therefor without departing from the spirit and scope of the invention. For example, one of the other pole clamps 12 illustrated herein may be substituted without departing from the spirit and scope of the invention.

The first rigid arm section 104 includes an externally convex shoulder portion 118 formed on the extension arm 116 opposing the second arm section 106 between the pole clamp 12 and its socket 112. The second arm section 106 is shorter than the first arm section 104 and includes an internally concave tail portion 120 at a second end thereof opposite from its socket 114. The internally concave tail portion 120 is positioned for forming a hinge 122 with the cooperating externally convex shoulder portion 118 of the first rigid arm section 104.

The adjustable clamping mechanism 70 is operable between the arm sections 104 and 106 for clamping the pair of sockets 112, 114 in the first loosely clamped state for forming relatively rotatable ball-and-socket joint 24 with the part-spherical coupler 18. The adjustable clamping mechanism 70 is further operable between the arm sections 104 and 106 for clamping the pair of sockets 112, 114 in the fully clamped state for securely interlocking the spacing mechanism 20 with the part-spherical coupler 18, as described herein.

The pole clamp 12 can be operated independently of the adjustable clamping mechanism 70 for positioning the detachable pole bracket 10 of the invention relative to the pole 3. With the pole clamp 12 in an initial unclamped state, the detachable pole bracket 10 is movable either translationally lengthwise along the pole 3, or rotationally around the pole 3. Subsequently, the pole clamp 12 is operated to clamp the pole 3 for securing the detachable pole bracket 10 in a selected lengthwise and rotational position on the pole 3. For example, here the nut 39 is tightened along the threaded bolt 37, which draws together the arms 27 and closes the aperture 33 about the pole 3.

With the detachable pole bracket 10 thus translationally and rotationally positioned on the pole 3, the concave tail portion 120 of the second arm section 106 is seated over the externally convex shoulder portion 118 of the first arm section 104, and the sockets 112, 114 form the ball-and-socket joint 24 with the part-spherical coupler 18. Accordingly, the caddy 14 is both rotationally and spherically adjustable within a spherical coordinate frame having its center at the second locus 52. Initially, the clamping mechanism 70 is operated for drawing together the arm sections 104, 106 in the first loosely clamped state for forming relatively rotatable ball-and-socket joint 24 with the part-spherical coupler 18. Operation of the clamping mechanism 70 draws together the arm sections 104, 106 with sufficient clamping force to ground the concave tail portion 120 of the second arm section 106 onto the convex shoulder portion 118 of the first arm section 104. Simultaneously, the respective socket portions 112, 114 are drawn together to form a single socket that is sized nearly the same diameter as the outer peripheral surface of the resiliently deformable ball that forms the part-spherical coupler 18. Accordingly, the first and second sockets 112, 114 form the relatively rotatable ball-and-socket joint 24 with the outer peripheral surface of the resiliently deformable part-spherical coupler 18, wherein the part-spherical coupler 18 fits snuggly within the sockets 112, 114, but can be cylindrically and spherically rotated about the second locus 52 within the sockets 112, 114. The caddy 14 can be cylindrically rotated on the stem 77 of the part-spherical coupler 18 by cylindrically rotating the ball-and-socket joint 24. Additionally, the ball-and-socket joint 24 permits the caddy 14 to be spherically rotated about the second locus 52 by spherically rotating the part-spherical coupler 18 in the sockets 112, 114.

The indentations 73 in the respective peripheral rims 65 permit the sockets 112, 114 to pass around the necked-down stem 77 of the part-spherical coupler 18. Thus, the spacing mechanism 20 can be rotated about the outer peripheral surface of the part-spherical coupler 18 to vary the angular orientation of the line of juncture 108 with respect to the stem 77 and its attachment.

The clamping mechanism 70 is operated to further rotate the handle 90 about the threaded bolt 72 to a second clamping position with the handle 90 in a fully-clamped position against the outer surfaces of the arm sections 104, 106. In this second clamping position, the concave tail portion 120 of the second arm section 106 is firmly seated over the externally convex shoulder portion 118 of the first arm section 104 to form the hinge 122 between the first and second arm sections 104, 106. The further clamping force exerted by the clamping mechanism 70 rotates the arm sections 104, 106 about the hinge 122 such that the clamping force exerted by the clamping mechanism 70 rotates the respective sockets 112, 114 toward each other and more closely together than the first intermediate or “light” clamping position. As a result of this rotation about the hinge 122, the inner peripheral surfaces of the respective socket portions 112, 114 are forced into still closer proximity whereby the sockets 112, 114 are sized having a diameter that is smaller than the outer peripheral surface of the resiliently deformable part-spherical coupler 18. The smaller distance between the sockets 112, 114 causes them to deform the outer peripheral surface of the resiliently deformable part-spherical coupler 18 to interlock the sockets 112, 114 with the resiliently deformable part-spherical coupler 18 and vice versa.

Optionally, the substantially smooth part spherical surfaces at the inner peripheries of the respective socket portions 112, 114 each include the “cruciate” grooves structured as two grooves 68 and forming a “cross” shape by crossing one another. The crossed grooves 68 inherently and by inspection must and do subdivide the part spherical surfaces of the sockets 112, 114 into four relatively smaller part spherical surfaces, and each of the four relatively smaller part spherical surfaces inherently and by inspection must and do terminate at the grooves 68 in the respective first sockets 112, 114 and the respective rims 65 thereabout. When the clamping mechanism 70 is advanced to the fully-clamped position, the “cruciate” grooves 68 engage the outer peripheral surface of the resiliently deformable part-spherical coupler 18, whereupon a portion of the surface of the resiliently deformable material of the part-spherical coupler 18 deforms or “flows” into the grooves 68. The portion of material that flows into the grooves 68 operate to further deform the outer peripheral surface of the resiliently deformable part-spherical coupler 18 to even more firmly interlock the sockets 112, 114 with the resiliently deformable part-spherical coupler 18 and vice versa.

The part-spherical coupler 18 is radially resiliently compressible because it is molded of resiliently deformable neoprene rubber. Therefore, when the clamping mechanism 70 is released from the second fully-clamped position to the first intermediate position of the clamping mechanism 70, the sockets 112, 114 are opened to again have a size that is nearly the same diameter as the outer peripheral surface of the resiliently deformable part-spherical coupler 18. The opened first and second sockets 112, 114 permit the part-spherical coupler 18 to resiliently expand to regain its original substantially smooth part spherical outer peripheral surface, whereupon the sockets 112, 114 and the part-spherical coupler 18 reform the relatively rotatable ball-and-socket joint 24. Thereupon, the connecting spacing mechanism 20 can be rotated about the part-spherical coupler 18 to vary the angular orientation of the caddy 14 on its stem 77 with respect to the line of juncture 108.

FIG. 8 is another view of the universal detachable pole bracket 10 of the invention wherein the spacing mechanism 20 includes the pole clamp 12 substituted for the first part-spherical coupler 16. Additionally, the second part-spherical coupler 18 is presented on the intervening coupler bracket 75 as being projected on the necked-down stem 77 from the flange 44. The caddy 14 can be mounted directly on the mounting platform 61 of the coupler bracket's flange 44. The caddy's mounting flange 98 is securely attached to the flange's mounting platform 61, and the drink container holder 81 or 83, the small tray 99, or both are disposed on the caddy's frame 97.

Here, the hinge 122 is illustrated by example and without limitation as being formed by an aperture 123 in the concave tail portion 120 of the second arm section 106 being fitted over the externally convex shoulder portion 118 in the extension arm 116 of the first arm section 104.

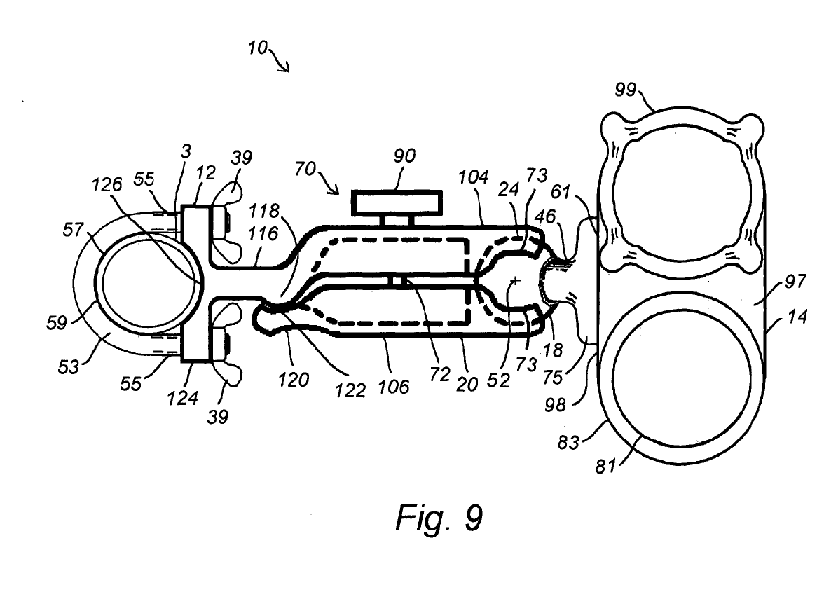

FIG. 9 illustrates the universal detachable pole bracket 10 of the invention having the spacing mechanism 20 configured with the pole clamp 12, as discussed above. Here by example and without limitation, the pole clamp 12 is configured similarly to the pole clamp illustrated in FIG. 4. By example and without limitation, the pole clamp 12 is configured having a yoke 124 with the concave surface 126 formed on one side and the rigid arm 116 extended from the opposite side. The single U-bolt 53 extends its two threaded arms 55 around the post 3 of the pole-type device stand 1, which pass through a yoke 124 on opposite sides of the concave surface 126. A pair of the wing nuts 39 secure the U-bolt 53 to the yoke 124. Tightening of the nuts 39 on the U-bolt 53 moves the concave surface 57 thereof toward the opposing concave surface 126 of the yoke 124, thereby reducing the size of the aperture 59 formed therebetween. In this manner, the clamp 12 can be adjusted to grip various different sizes of the post 3 of the pole-type device stand 1.

Furthermore, the accessory support bracket 97 is securely attached to the flange's mounting platform 61, and the drink container holder 81 or 83 and the small tray 99 are both disposed on the caddy's bracket 97.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1: A universal detachable pole bracket that provides positional adjustments of a caddy within a spherical coordinate frame, the bracket comprising:
two releasably interlockable rotationally and spherically rotatable ball-and-socket components formed between a substantially rigid spacing component and two part-spherical couplers;
a pole clamp mechanism being coupled to one of the two part-spherical couplers, the pole clamp mechanism being structured for attachment to a pole; and
a caddy being coupled to a different one of the two part-spherical couplers.

2: The bracket of claim 1 wherein the caddy further comprises an accessory support bracket coupled to the part-spherical coupler, the accessory support bracket having a drink container holder and being structured to support the drink container holder in a substantially upright orientation.

3: The bracket of claim 2, further comprising a coupler bracket intervening between the caddy and the part-spherical coupler, the intervening coupler bracket comprising a flange having the part-spherical coupler presented on a substantially rigid stem projected from one side thereof and being structured with a mounting platform on a different side thereof.

4: The bracket of claim 1 wherein the caddy further comprises a drink container holder coupled to the part-spherical coupler.

5: The bracket of claim 1 wherein at least a first one of the two part-spherical couplers further comprises a resiliently deformable material having a substantially smooth part spherical outer surface; and
the spacing component further comprises two substantially rigid arm sections forming two pairs of sockets therebetween, at least a first pair of the two pairs of sockets having substantially smooth and rigid concave interior surfaces shaped to substantially conform to the part spherical outer surface portion of the first resiliently deformable part-spherical coupler.

6: The bracket of claim 5, further comprising an adjustable clamping mechanism operable between the two substantially rigid arm sections for urging the substantially smooth and rigid concave interior surfaces of the first pair of sockets to form a first one of the rotationally and spherically rotatable ball-and-socket components with the first resiliently deformable part-spherical coupler, and being further operable between the two substantially rigid arm sections for urging the substantially smooth and rigid concave interior surfaces of the first pair of sockets to releasably interlock with the outer surface of the first resiliently deformable part-spherical coupler.

7: The bracket of claim 6 wherein a second one of the two part-spherical couplers further comprises a resiliently deformable material having a substantially smooth part spherical outer surface;
a second pair of the two pairs of sockets formed between substantially rigid arm sections further comprises substantially smooth and rigid concave interior surfaces shaped to substantially conform to the part spherical outer surface portion of the second resiliently deformable part-spherical coupler; and
the adjustable clamping mechanism is further operable between the two substantially rigid arm sections for urging the substantially smooth and rigid concave interior surfaces of the second pair of sockets to form a second one of the rotationally and spherically rotatable ball-and-socket components with the second resiliently deformable part-spherical coupler, and being further operable between the two substantially rigid arm sections for urging the substantially smooth and rigid concave interior surfaces of the second pair of sockets to releasably interlock with the outer surface of the second resiliently deformable part-spherical coupler.

8: The bracket of claim 7, further comprising a differential biasing mechanism coupled for differentially urging apart one of the first and second pairs of sockets, and further coupled for urging together a different one of the first and second pairs of sockets.

9: A universal detachable pole bracket that provides positional adjustments of a caddy within a spherical coordinate frame, the bracket comprising:
first and second part-spherical couplers each formed of a resiliently deformable material having a substantially smooth part spherical outer surface, one of the first and second part-spherical couplers being projected from a pole clamp mechanism on a substantially rigid stem, and a different one of the first and second part-spherical couplers being projected from a caddy on a different substantially rigid stem;
a substantially rigid spacing component formed of a pair of substantially rigid arm sections forming first and second pairs of sockets adjacent to opposite ends thereof, each of the first and second pairs of arm sections being formed with substantially smooth and rigid concave interior surfaces shaped to substantially conform to the part spherical outer surface portion of the respective first and second resiliently deformable part-spherical couplers;
a differential biasing mechanism coupled between the arm sections of the spacing component for differentially urging apart one of the first and second pairs of sockets, and simultaneously urging together a different one of the first and second pairs of sockets; and
an adjustable clamping mechanism operable with the spacing component for urging the first and second pairs of sockets of the two substantially rigid arm sections into each of three sequential adjustment relationships to the respective first and second part-spherical couplers, the three sequential adjustment relationships comprising:
a first loosely clamped relationship forming first and second relatively rotatable ball-and-socket joints between the first and second pairs of sockets and the part spherical outer surface portions of the respective first and second part-spherical couplers,
a second partially clamped relationship securely interlocking the first pair of sockets with the part spherical outer surface portion of the first part-spherical coupler, while retaining the second relatively rotatable ball-and-socket joint between the second pair of sockets and the part spherical outer surface portions of the second part-spherical coupler, and
a third fully clamped relationship securely interlocking the first and second pairs of sockets with the part spherical outer surface portions of the respective first and second part-spherical couplers.

10: The bracket of claim 9 wherein the caddy further comprises a substantially rigid drink container holder.

11: The bracket of claim 10 wherein the caddy further comprises a substantially rigid accessory support bracket structured for supporting both the drink container holder and a tray in substantially upright orientations.

12: A method for positionally adjusting a detachable caddy within a spherical coordinate frame, the method comprising:
providing two releasably interlockable rotationally and spherically rotatable ball-and-socket components between a substantially rigid spacing component and two part-spherical couplers;
coupling a pole clamp mechanism to one of the two part-spherical couplers;
coupling a caddy to a different one of the two part-spherical couplers;
spherically rotating one or both of the two part-spherical couplers relative to the substantially rigid spacing component for spherically and rotationally adjusting a position and orientation of one of the caddy relative to the pole clamp mechanism; and
subsequently releasably interlocking both of the two ball-and-socket components.

13: The method of claim 12, further comprising forming at least a first one of the two part-spherical couplers of a resiliently deformable material having a substantially smooth part spherical outer surface.

14: The method of claim 13 wherein providing two releasably interlockable rotationally and spherically rotatable ball-and-socket components between a substantially rigid spacing component and two part-spherical couplers further comprises forming two pairs of sockets between two substantially rigid arm sections, including forming at least a first pair of the two pairs of sockets with substantially smooth and rigid concave interior surfaces shaped to substantially conform to the part spherical outer surface portion of the first resiliently deformable part-spherical coupler.

15: The method of claim 14, further comprising operating an adjustable clamping mechanism between the two substantially rigid arm sections for initially urging the substantially smooth and rigid concave interior surfaces of the first pair of sockets to form a first one of the rotationally and spherically rotatable ball-and-socket components with the first resiliently deformable part-spherical coupler, and further operating the adjustable clamping mechanism between the two substantially rigid arm sections for subsequently urging the substantially smooth and rigid concave interior surfaces of the first pair of sockets to releasably interlock with the outer surface of the first resiliently deformable part-spherical coupler.

16: The method of claim 15, further comprising forming a second one of the two part-spherical couplers of a resiliently deformable material having a substantially smooth part spherical outer surface; and
wherein: forming two pairs of sockets between two substantially rigid arm sections further comprises forming a second pair of the two pairs of sockets with substantially smooth and rigid concave interior surfaces shaped to substantially conform to the part spherical outer surface portion of the second resiliently deformable part-spherical coupler; and
operating an adjustable clamping mechanism between the two substantially rigid arm sections further comprises operating the adjustable clamping mechanism for urging the substantially smooth and rigid concave interior surfaces of the second pair of sockets to form a second one of the rotationally and spherically rotatable ball-and-socket components with the second resiliently deformable part-spherical coupler, and further operating the adjustable clamping mechanism between the two substantially rigid arm sections for urging the substantially smooth and rigid concave interior surfaces of the second pair of sockets to releasably interlock with the outer surface of the second resiliently deformable part-spherical coupler.

17: The method of claim 16, further comprising urging apart one of the first and second pairs of sockets, and substantially simultaneously urging together a different one of the first and second pairs of sockets.

18: A method for positionally adjusting a detachable caddy within a spherical coordinate frame, the method comprising:
rigidly projecting one of two part-spherical couplers from a pole clamp mechanism;
rigidly projecting a different one of the two part-spherical couplers from a caddy;
forming two rotationally and spherically rotatable ball-and-socket components between the two part-spherical couplers and two corresponding pairs of complementary sockets adjacent to opposite ends of a substantially rigid spacing component;
spherically rotating one or both of the two part-spherical couplers within the two corresponding pairs of complementary sockets relative to the substantially rigid spacing component for spherically and rotationally adjusting a relative position and orientation of the caddy to the caddy clamp mechanism; and
subsequently immobilizing both of the two ball-and-socket components.

19: The method of claim 18, further comprising forming the two part-spherical couplers of a resiliently deformable material having a substantially smooth part spherical outer surface; and
forming the two pairs of complementary sockets having substantially smooth and rigid concave interior surfaces shaped to substantially conform to the part spherical outer surface portion of the corresponding resiliently deformable part-spherical coupler.

20: The method of claim 19, further comprising clamping together the two pairs of complementary sockets in an initial relationship with the two corresponding part-spherical couplers wherein the two rotationally and spherically rotatable ball-and-socket components are formed therebetween, and a final relationship wherein both of the two ball-and-socket components are relatively immobilized.

21: The method of claim 20, further comprising clamping together the two pairs of complementary sockets in an intermediate relationship with the two corresponding part-spherical couplers wherein one of the two rotationally and spherically rotatable ball-and-socket components is formed therebetween, and a different one of the two ball-and-socket components is relatively immobilized.

22: The method of claim 21, further comprising urging apart one of the two pairs of complementary sockets, and substantially simultaneously urging together a different one of the two ball-and-socket components.

23: A method for positionally adjusting a detachable music stand within a spherical coordinate frame, the method comprising:
on respective substantially rigid stem portions projecting from respective flange members, forming each of two part-spherical couplers of a resiliently deformable material having a substantially smooth part-spherical outer surface;
coupling the flange member of one of the two part-spherical couplers to a pole clamp mechanism;
coupling the pole clamp mechanism to a pole;
coupling the flange member of a different one of the two part-spherical couplers to a caddy;
in opposite ends of a substantially rigid spacing component, forming pairs of complementary sockets having substantially smooth and rigid concave interior surfaces shaped to substantially conform to the part-spherical outer surface portion of a corresponding one of the resiliently deformable part-spherical couplers;
operating an adjustable clamping mechanism for forming respective rotationally and spherically rotatable ball-and-socket components between the two part-spherical couplers and respective ones of the two pairs of complementary sockets;
spherically rotating one or both of the two part-spherical couplers within the two corresponding pairs of complementary sockets relative to the substantially rigid spacing component for spherically and rotationally adjusting a spherical position and orientation of the caddy relative to the pole; and
subsequently operating the adjustable clamping mechanism for immobilizing both of the two ball-and-socket components.

24: The method of claim 23, further comprising operating the adjustable clamping mechanism for forming one of the rotationally and spherically rotatable ball-and-socket components between one of the two part-spherical couplers and the respective one of the two pairs of complementary sockets, and substantially simultaneously operating the adjustable clamping mechanism for immobilizing a different one of the two ball-and-socket components.

25: The method of claim 24, further comprising positioning a resilient differential biasing mechanism for urging apart one of the two pairs of complementary sockets, and substantially simultaneously urging together a different one of the two ball-and-socket components.
